(19) United States
(12) Patent Application Publication
(10) Pub. No.: US 2009/0168281 A1
(43) Pub. Date: Jul. 2, 2009

(54) ELECTROSTATIC DISCHARGE LEADING CIRCUIT

(75) Inventor: Jung-Yen Kuo, Yunlin County (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/124,459

(22) Filed: May 21, 2008

(30) Foreign Application Priority Data
Dec. 26, 2007 (TW) 096150270

(51) Int. Cl. H02H 9/04

(52) U.S. Cl. 361/56

(57) ABSTRACT

An electrostatic discharge (ESD) leading circuit for a large-sized open drain circuit is provided. The ESD leading circuit utilizes a gate voltage boosting circuit to increase the gate voltage of an N-type MOS transistor.

### BACKGROUND OF THE INVENTION

1. Field of the Invention

The invention relates to an electrostatic discharge (ESD) leading circuit, and more particularly to an ESD leading circuit for a large-sized open-drain circuit.

2. Description of the Related Art

Because electrostatic force from the environment or humans damage circuits, a circuit group is typically disposed in the circuit for increasing the operating lifespan of the circuit. The circuit group refers to an electrostatic discharge (ESD) protection circuit. For conventional technology, the ESD protection circuit typically comprises two structures. One structure is a Ballast resistor and other structure is an ESD clamping circuit. However, since a parasitic N-type metal oxide semiconductor (MOS) transistor of a circuit may be abnormally turned on, ESD protection performance may be reduced. When the Ballast resistor is added in the circuit, the parasitic N-type metal oxide semiconductor (MOS) transistor can be normally turned on.

The ESD clamping circuit leads a portion or all of ESD current. FIG. 1 is a conventional output circuit comprising an ESD clamping circuit. The output circuit 1 comprises an ESD clamping circuit 11. The ESD clamping circuit is coupled between a voltage source and grounding 12 The voltage source provides voltage VCC. The output circuit 1 further comprises a P-type MOS transistor 13 and an N-type MOS transistor 14 and a parasitic diode 15. The P-type MOS transistor 13 comprises a source receiving the voltage VCC, and a drain coupled to an output terminal 16. The N-type MOS transistor 14 comprises a source coupled to the grounding 12, and a drain coupled to the output terminal 16. The parasitic diode 15 receives the voltage VCC. The output terminal 16 is coupled to the parasitic diode 15. In PS mode, an ESD current flows through the parasitic diode 15, the voltage source, and the ESD clamping circuit 11 and finally to the grounding 12. Thus, the ESD current does not damage the circuit.

For a large-sized output circuit, the impedance of turning on a resistor existing between the drain and the source of transistor is required to be low. However, the Ballast resistor increases the impedance of turning on the resistor. Thus, due to aforementioned factor concerning the Ballast resistor and consideration for layout size, either the impedance of the Ballast resistor is reduced or the large-sized output circuit does not utilize the Ballast resistor. Thus, the parasitic NPN transistor is hardly turned on. Assuming an output circuit comprises an open-drain N-type MOS transistor having a large size. Typically, the output circuit does not comprise the Ballast resistor or the impedance of the Ballast resistor is reduced. Thus, ESD protection performance is poor, because the parasitic forward bias diode causes the ESD current to the NMOS transistor.

FIG. 2 is a conventional output circuit, which comprises an open drain NMOS having a large size. For the output circuit 2, the first parasitic capacitor 21 and the second parasitic capacitor 22 provide divided voltage such that the first N-type MOS transistor 23 is normally turned on. However, when an ESD event occurs, a power line 27 is charged via the first parasitic capacitor 21 and the parasitic diode 25. If the capacitor 26, coupled between the power line 27 and the grounding 28, is higher than the first parasitic capacitor 21, the power line 27 is charged to an unsatisfactory voltage level. Thus, the gate voltage of the first N-type MOS transistor 23 is unsatisfactory such that the impedance of the first N-type MOS transistor 23 is higher. Therefore, ESD protection performance is reduced. Additionally, if the second N-type MOS transistor 24 is turned on, the gate voltage of the first N-type MOS transistor 23 equals to the voltage of the grounding 28.

### BRIEF SUMMARY OF THE INVENTION

ESD leading circuits are provided. An exemplary embodiment of an ESD leading circuit is applied to an output circuit and comprises a voltage source, a first P-type MOS transistor, a first N-type MOS transistor, a parasitic diode, a second N-type MOS transistor, a first parasitic capacitor, a second parasitic capacitor, and a gate voltage boosting circuit. The voltage source provides a voltage. The first P-type MOS transistor is coupled to the voltage source. The first N-type MOS transistor is coupled to the first P-type MOS transistor. The parasitic diode is coupled to the first P-type MOS transistor. The second N-type MOS transistor is coupled to a drain of the first P-type MOS transistor. The first parasitic capacitor is coupled to the second N-type MOS transistor. The second parasitic capacitor is coupled to the first parasitic capacitor and the second N-type MOS transistor. The gate voltage boosting circuit is coupled to a gate and a drain of the second N-type MOS transistor and comprises a third N-type MOS transistor, a first capacitor, a grounding, and a first resistor. The first capacitor is coupled to a drain of the third N-type MOS transistor. The first resistor is coupled to the first capacitor and the grounding.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a conventional output circuit comprising an ESD clamping circuit;

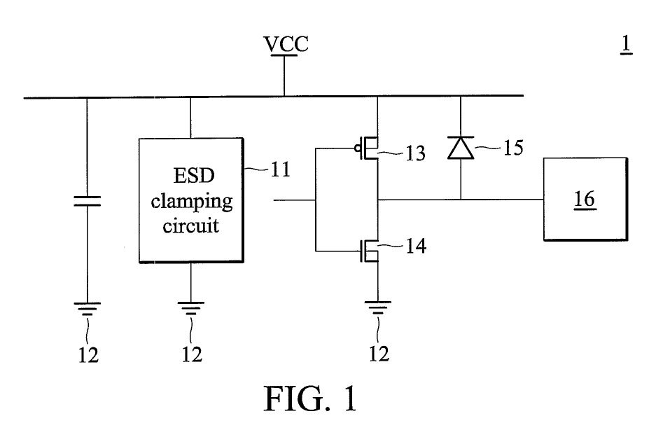

FIG. 2 is a conventional output circuit, which comprises an open drain NMOS having a large size; and

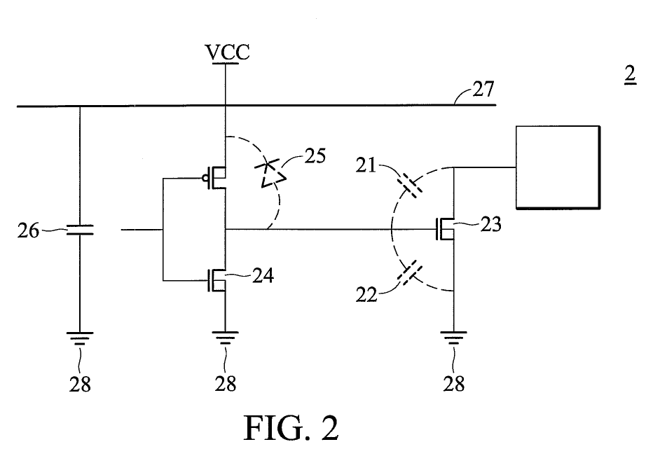

FIG. 3 is a schematic diagram of an exemplary embodiment of an ESD leading circuit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

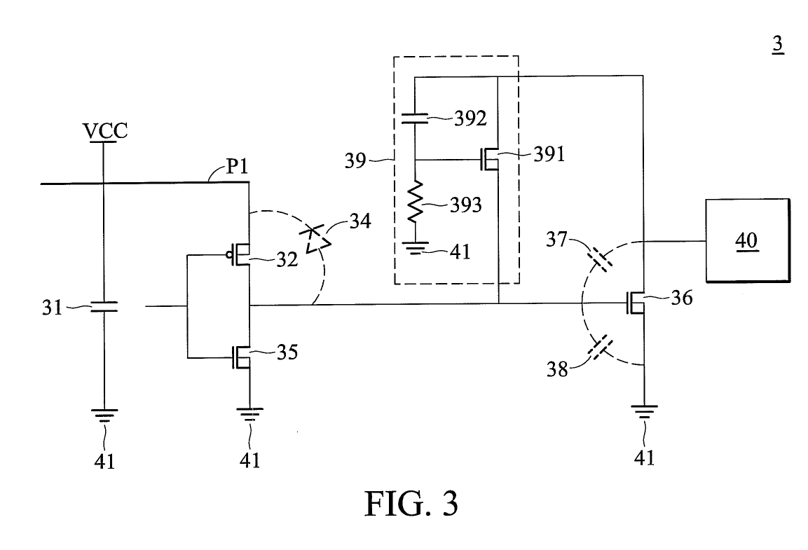

FIG. 3 is a schematic diagram of an exemplary embodiment of an ESD leading circuit. The ESD leading circuit 3 comprises a voltage source generating a voltage VCC, a capacitor 31, a first P-type MOS transistor 32, a first N-type MOS transistor 35, a parasitic diode 34, a second N-type MOS transistor 36, a first parasitic capacitor 37, a second parasitic capacitor 38, a gate voltage boosting circuit 39, an output unit 40 and a grounding 41.

One terminal of the capacitor 31 receives the voltage VCC and the other terminal of the capacitor 31 is coupled to the grounding 41. A source of the first P-type MOS transistor 32 receives the voltage VCC. The first N-type MOS transistor 35 comprises a drain coupled to a drain of the first P-type MOS transistor 32, a gate coupled to a gate of the first P-type MOS transistor 32, and a source coupled to the grounding 41. The parasitic diode 34 is coupled-between the source and the drain of the first P-type MOS transistor 32.

The second N-type MOS transistor 36 comprises a gate coupled to the drain of the first P-type MOS transistor 32, a source coupled to the grounding 41, and a drain coupled to the output unit 40. The first parasitic capacitor 37 connects to the second parasitic capacitor 38 in serial between the source and the drain of the second N-type MOS transistor 36.

The gate voltage boosting circuit 39 is coupled to the drain of the second N-type MOS transistor 36 and comprises a third N-type MOS transistor 391, a first capacitor 392, a first resistor 393 and the grounding 41. The first resistor 393 is coupled between one terminal of the first capacitor 392 and the grounding 41. The other terminal of the first capacitor 392 is coupled to a drain of the third N-type MOS transistor 391. A source of the third N-type MOS transistor 391 is coupled to the gate of the second N-type MOS transistor 36. A gate of the third N-type MOS transistor 391 is coupled to the first resistor 393.

The gate voltage boosting circuit 39 increases the gate voltage of the second N-type MOS transistor 36 such that a power line Pl does not have to be, charged to an unsatisfactory voltage level. The gate voltage of the second N-type MOS transistor 36 is satisfactory such that the channel of the second N-type MOS transistor 36 is turned on. Thus, ESD protection performance is increased.

As discussed above, the problems, whereby the gate voltage of the N-type MOS transistor is low and the channel of the N-type MOS transistor is abnormally turned on, are mitigated due to ESD leading circuit of the invention. Thus, increasing ESD protection performance.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrostatic discharge (ESD) leading circuit for an output circuit, comprising:
a voltage source providing a voltage;
a first P-type metal oxide semiconductor (MOS) transistor coupled to the voltage source;
a first N-type MOS transistor coupled to the first P-type MOS transistor;
a parasitic diode coupled to the first P-type MOS transistor;
a second N-type MOS transistor coupled to a drain of the first P-type MOS transistor;
a first parasitic capacitor coupled to the second N-type MOS transistor;
a second parasitic capacitor coupled to the first parasitic capacitor and the second N-type MOS transistor; and
a gate voltage boosting circuit coupled to a gate and a drain of the second N-type MOS transistor and comprising:
a third N-type MOS transistor;
a first capacitor coupled to a drain of the third N-type MOS transistor;
a grounding; and
a first resistor coupled to the first capacitor and the grounding.
